(19) United States
(12) Patent Application Publication
(10) Pub. No.: US 2014/0062911 A1
(43) Pub. Date: Mar. 6, 2014

(54) DISPLAY DEVICE FOR CONNECTING A TOUCH DEVICE AND COMPUTER SYSTEM THEREWITH

(71) Applicant: WISTRON CORPORATION, New Taipei City (TW)

(72) Inventors: Chih-Yao Wu, New Taipei City (TW); Chih-Kang Chen, New Taipei City (TW); Chih-Kai Huang, New Taipei City (TW)

(73) Assignee: WISTRON CORPORATION, New Taipei City (TW)

(21) Appl. No.: 13/776,666

(22) Filed: Feb. 25, 2013

(30) Foreign Application Priority Data
Sep. 4, 2012 (TW) 101132210

(51) Int. Cl. G06F 3/041

(52) U.S. Cl. CPC G06F 3/041
USPC 345/173

(57) ABSTRACT

The present invention discloses a display device for connecting a touch device. The display device includes a display screen, a screen stand and a signal transmission port. The screen stand is connected to the display screen and for supporting the display screen. A slot is formed on a side of the screen stand and for accommodating the touch device. The signal transmission port is installed on an end of the slot for connecting with a connection port of the touch device as the touch device is inserted into the slot, to transmit signals to the connection port, so that the display screen displays images corresponding to the signals transmitted from the touch device.

### BACKGROUND OF THE INVENTION

1. Field of the Invention

The present invention relates to a display device capable of connecting with a touch device and a related computer system, and more specifically, to an integral mechanical design by inserting a touch device into a slot of a display device to connect the touch device with the display device.

2. Description of the Prior Art

A portable touch device has an advantage of easy carry. Furthermore, the portable touch device is easy to operate and has a touch screen with a touch function as a human machine interface for inputting commands. On the other hand, a size of the touch device is limited to convenience of mobility, so that the touch device cannot display as a large screen of a desktop computer. However, the large screen of the desktop computer with a touch module has an expensive cost, and a touch operation on a large area is not ergonomic. A common solution is to transmit an image of a touch mobile device onto the large screen by using wireless transmission or using a cable, but it has to be implemented by complicated internet setting or by preparing the cable, resulting in complexity of data transmission. In addition, the conventional connection does not provide a mechanism for fixing the touch mobile device on the desktop computer, so that it cannot facilitate users to operate.

### SUMMARY OF THE INVENTION

The present invention is to provide a display device capable of connecting with a touch device and a related computer system to solve the above problems.

According to the disclosure, the present invention discloses a display device for connecting a touch device. The display device includes a display screen, a screen stand and a signal transmission port. The screen stand is connected to the display screen and for supporting the display screen. A slot is formed on a side of the screen stand and for accommodating the touch device. The signal transmission port is installed on an end of the slot for connecting with a connection port of the touch device as the touch device is inserted into the slot, to transmit signals to the connection port, so that the display screen displays images corresponding to the signals transmitted from the touch device.

According to the disclosure, the screen stand includes a stand body and a plate. The slot is disposed at a side of the stand body. The plate is connected to the stand body, and a tilt angle is formed between the slot and the plate.

According to the disclosure, a predetermined height is set between the slot and the plate, so that a containing space is formed between the touch device and the plate as the touch device is inserted into the slot.

According to the disclosure, the display device further includes an adjustment module detachably installed inside the slot for adjusting a size of an opening of the slot.

According to the disclosure, at least one hook is disposed at the end of the slot for engaging with at least one engaging portion of the touch device, so as to fix the touch device inside the slot.

According to the disclosure, at least one positioning column is disposed at the end of the slot for positioning at least one positioning portion of the touch device as the touch device is inserted into the slot.

According to the disclosure, the signal transmission port is a HDMI (High Definition Multimedia Interface) port.

According to the disclosure, a computer system includes a touch device and a display device. The touch device includes a connection port. The display device is for connecting the touch device and displaying images of signals transmitted from the touch device. The display device includes a display screen, a screen stand and a signal transmission port. The screen stand is connected to the display screen for supporting the display screen, and a slot is formed on a side of the screen stand for accommodating the touch device. The signal transmission port is installed on an end of the slot for connecting with the connection port of the touch device as the touch device is inserted into the slot, to transmit the signals to the connection port, so that the display screen displays the images corresponding to the signals transmitted from the touch device.

The present invention utilizes a structural design of inserting the touch device into the slot of the display device to achieve a purpose of operating the computer system with the dual-screen function. As the touch device is inserted into the slot, the predetermined height is set under the touch device, so as to provide the moving space for the touch device to insert into the slot and unplug from the slot. The containing space also facilitates other peripheral input devices to be contained in the containing space underneath the touch device. In addition, because the slot is designed with the tilt angle, the touch device and the supporting surface for supporting the computer system also form the tilt angle as the touch device is inserted into the slot. The tilt angle can facilitate users to browse the display screen and the screen of the touch device, and it is also suitable for users to perform the touch operation on the touch device, so as to provide the ergonomic mechanical design.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 4 are respectively diagrams of a computer system in different using states and in different views according to an embodiment of the present invention.

FIG. 5 and FIG. 6 are respectively inner structural diagrams of a touch device being not combined with a display device and of the touch device being combined with the display device according to the embodiment of the present invention.

FIG. 7 and FIG. 8 are respectively diagrams of the computer system in different states according to another embodiment of the present invention.

FIG. 9 and FIG. 10 are respectively diagrams of the touch device and a keyboard in different relative positions according to another embodiment of the present invention.

### DETAILED DESCRIPTION

In the following detailed description of the preferred embodiments, reference is made to the accompanying drawings which form a part hereof, and in which is shown by way of illustration specific embodiments in which the invention maybe practiced. In this regard, directional terminology, such as “top,” “bottom,” “front,” “back,” etc., is used with reference to the orientation of the Figure (s) being described. The components of the present invention can be positioned in a number of different orientations. As such, the directional terminology is used for purposes of illustration and is in no way limiting.

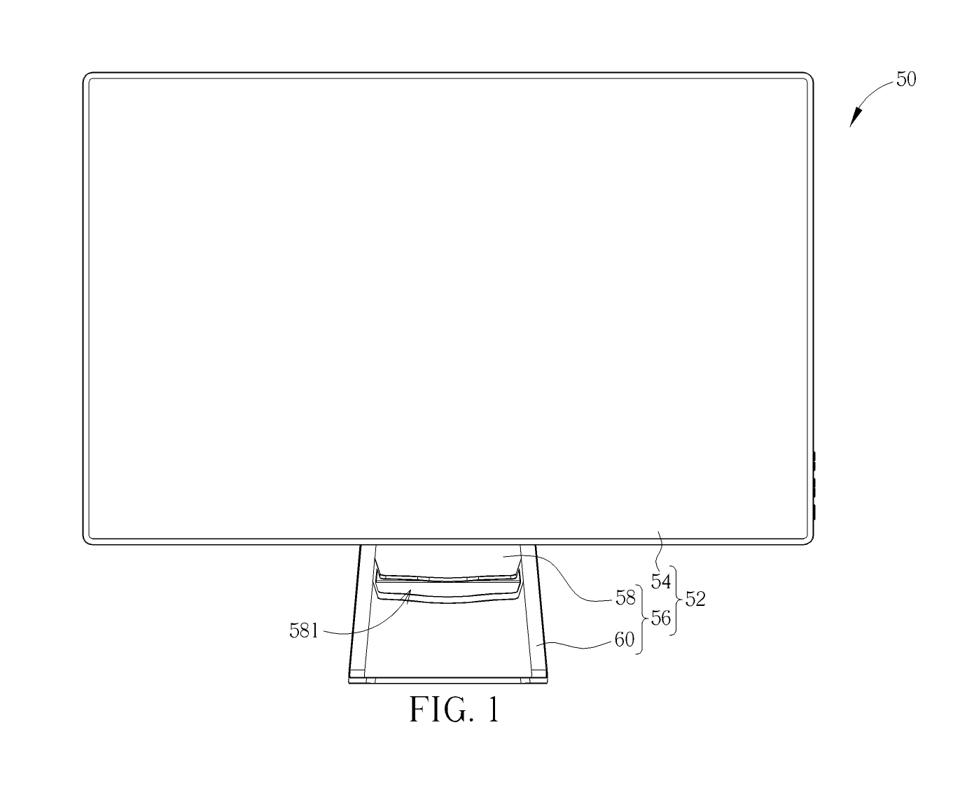

Please refer to FIG. 1 to FIG. 4. FIG. 1 to FIG. 4 are respectively diagrams of a computer system 50 in different using states and in different views according to an embodiment of the present invention. The computer system 50 includes a display device 52 for displaying images. The display device 52 can be a liquid crystal display device. The display device 52 includes a display screen 54 and a screen stand 56. The screen stand 56 is connected to the display screen 54 for supporting the display screen 54. The screen stand 56 includes a stand body 58 and a plate 60. The stand body 58 is connected to the display screen 54, and the plate 60 is connected to the stand body 58 for being disposed on a supporting surface, such as on a desk. A slot 581 is formed on a side of the stand body 58, a tilt angle θ is formed between the slot 581 and the plate 60, and a predetermined height H is set between the slot 581 and the plate 60.

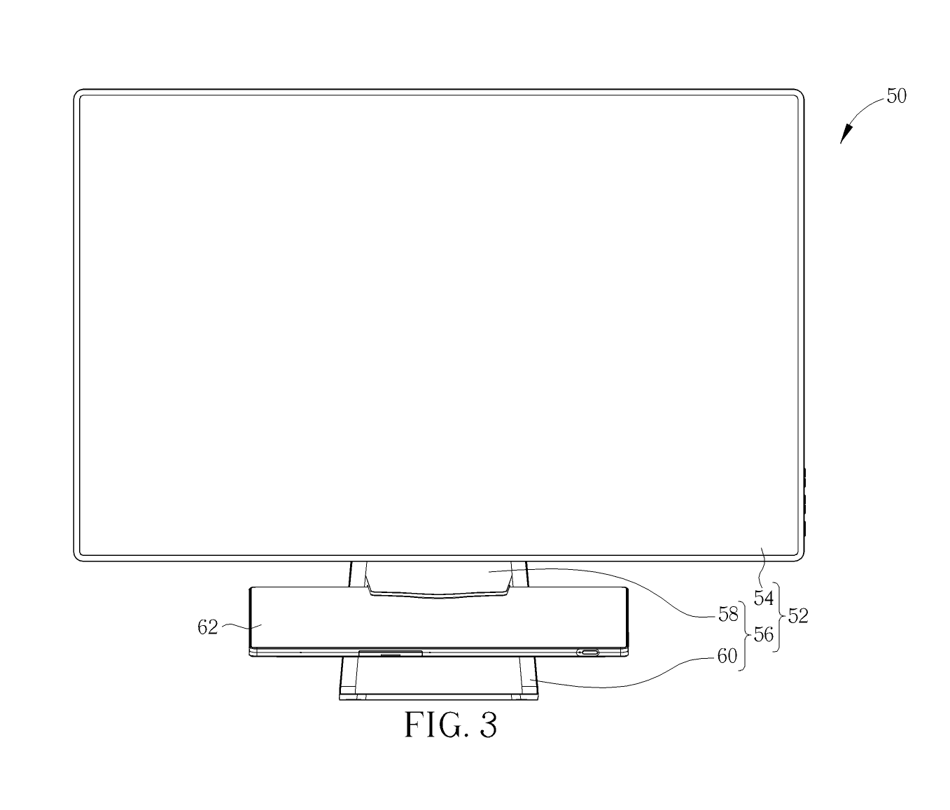

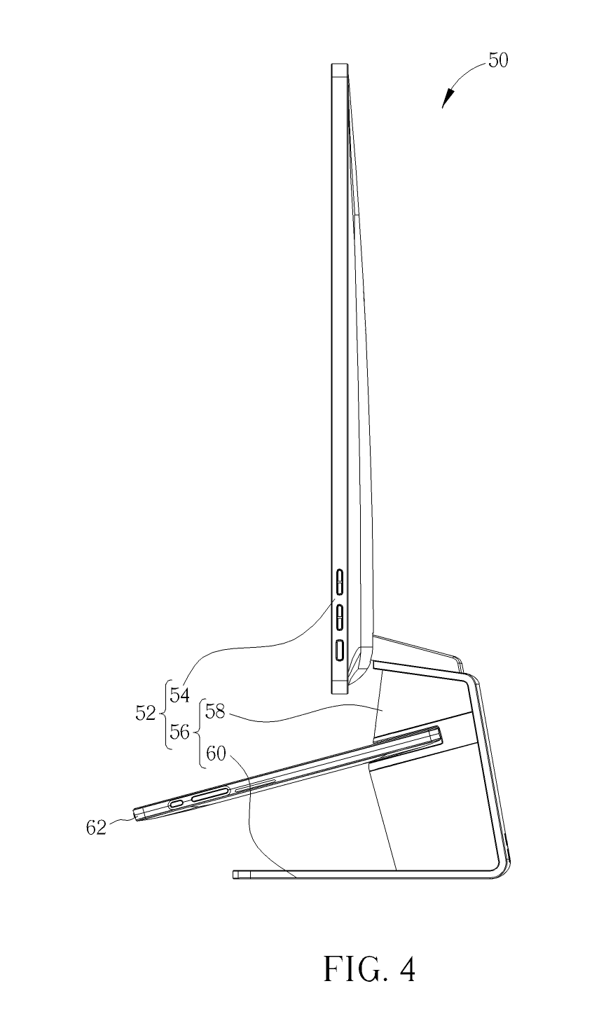

The computer system 50 further includes a touch device 62 which can be a touch tablet device. As shown in FIG. 3 and FIG. 4, the touch device 62 can be inserted into the slot 581 of the stand body 58. That is, the slot 581 is for accommodating the touch device 62. As users only use the touch device 62, users can carry the touch device 62 due to better mobility of the touch device 62. As the touch device 62 is inserted into the display device 52, the touch device 62 can transmit signals to the display device 52, so that the touch device can perform computing function continuously and display corresponding images on the display screen 54 with a lager size. If peripheral input devices, such as a keyboard or a mouse, are configured, a combination of the touch device 62 and the display device 52 can act as a desktop computer with full functions, so as to implement the desktop computer with a touch function easily. Moreover, a dual-screen architecture of a screen of the touch device 62 and the display screen 54 can be designed that the display screen 54 with the lager size can display an operational windows interface, and the screen of the touch device 62 can display a touch input interface for facilitating users to perform a touch operation. As a result, users can use the computer with the touch operation and can perform dual-screen function to split different software onto different display screens.

Furthermore, the predetermined height H is set between the slot 581 and the plate 60, so that a containing space is formed between the touch device 62 and the plate 60 as the touch device 62 is inserted into the slot 581, so as to provide a moving space for the touch device 62 to insert into the slot 581 or unplug from the slot 581. The containing space also facilitates other peripheral input devices, such as the keyboard, to be contained under the touch device 62. That is, the computer system 50 can provide the keyboard for key-in operation and the touch interface of the touch device 62 for touch operation at the same time. In addition, the tilt angle θ is formed between the slot 581 and the plate 60, so that the tilt angle θ is also formed between the touch device 62 and the supporting surface for supporting the plate 60 as the touch device 62 is inserted into the slot 581. The tilt angle θ can facilitate users to browse the display screen 54 and the screen of the touch device 62, and it is also suitable for users to perform the touch operation on the touch device 62, so as to provide an ergonomic mechanical design.

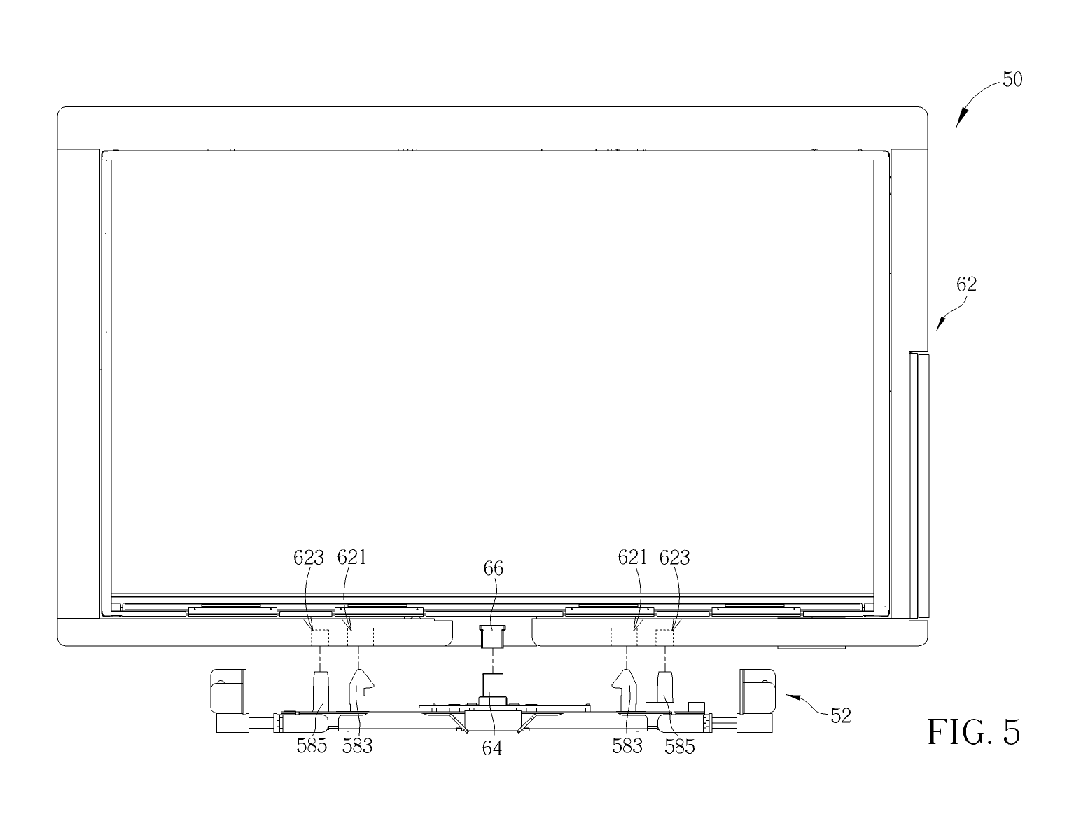

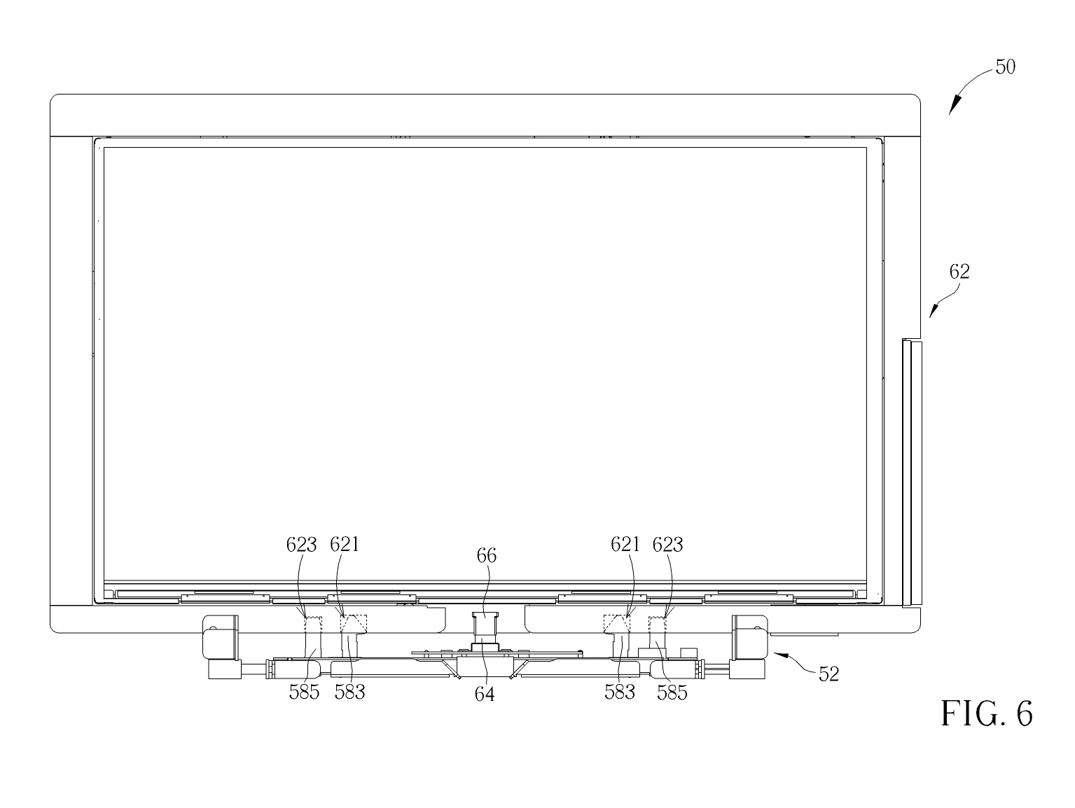

Please refer to FIG. 5 and FIG. 6. FIG. 5 and FIG. 6 are respectively inner structural diagrams of the touch device 62 being not combined with the display device 52 and of the touch device 62 being combined with the display device 52 according to the embodiment of the present invention. The display device 52 further includes a signal transmission port 64 installed on an end of the slot 581, and the touch device 62 includes a connection port 66. The signal transmission port 64 of the display device 52 is for connecting with the connection port 66 of the touch device 62 as the touch device 62 is inserted into the slot 581, and therefore signals can be transmitted between the signal transmission port 64 and the connection port 66, so that the display screen 54 can display the images corresponding to the signals transmitted from the touch device 62. The connection port 66 of the touch device 62 and the signal transmission port 64 of the display device 52 can be respectively a HDMI (High Definition Multimedia Interface) port, so that sound signals and image signals can be transmitted via the single transmission port, and it can simplify a combination mechanism of the touch device 62 and the display device 52. Furthermore, in order to combine the touch device 62 with the display device 52 stably, at least one hook 583 and at least one positioning column 585 are disposed at the end of the slot 581, and the touch device 62 can further include at least one engaging portion 621 and at least one positioning portion 623. The engaging portion 621 and the positioning portion 623 can be respectively a slot structure.

As the touch device 62 is inserted into the slot 581, each positioning column 585 can be inserted into the corresponding positioning portion 623. That is, the positioning portion 623 can guide the positioning column 585 to move, so that the touch device 62 can be positioned smoothly and accurately. At this time, each hook 583 can be engaged with the corresponding engaging portion 621, so as to fix the touch device 62 in the slot 581. Because the hook 583 can be made of a resilient material, the hook 583 can resiliently deform as passing through the engaging portion 621. As the hook 583 is installed inside the engaging portion 621, the hook 583 and the engaging portion 621 can be hooked tightly, so that the touch device 62 is not easily separated from the slot 581. In this embodiment, two hooks 583 and two positioning columns 585 are respectively disposed at the end of the slot 581 and at two sides of the signal transmission port 64. The touch device 62 accordingly includes two engaging portions 621 and two positioning portions 623 respectively disposed at two sides of the connection port 66. By symmetric structural design of the hooks 583, the positioning columns 585, the engaging portions 621 and the positioning portions 623 relative to the signal transmission port 64 and the connection port 66, it can position the touch device 62 accurately and can fix the touch device 62 in the slot 581 stably.

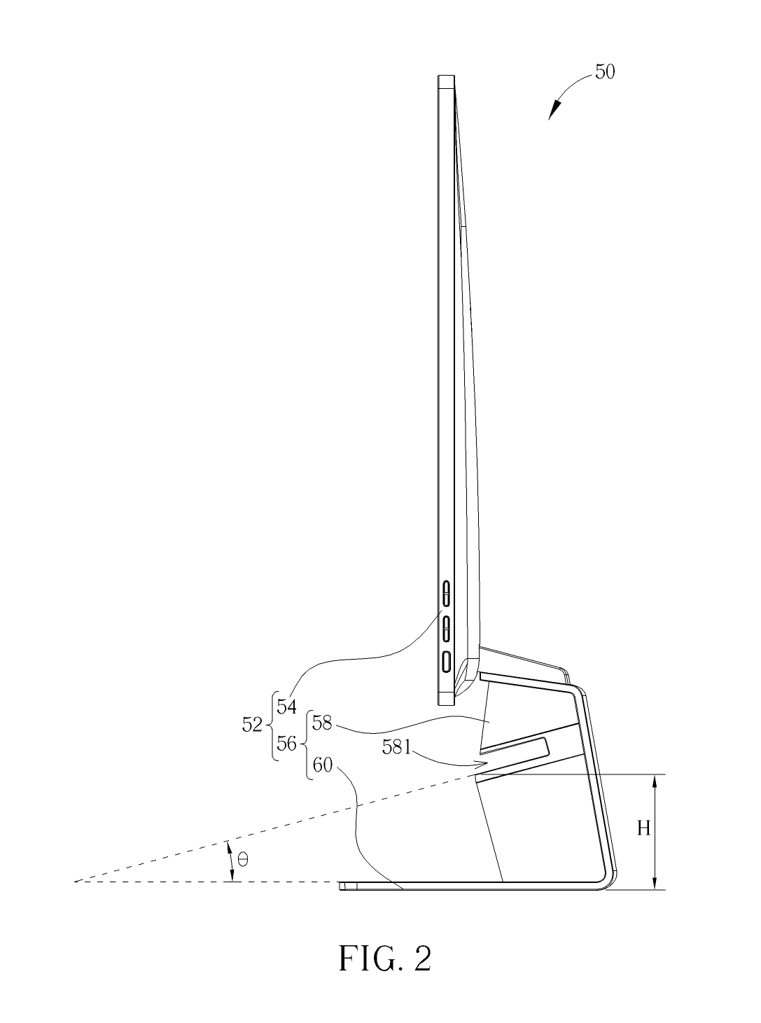

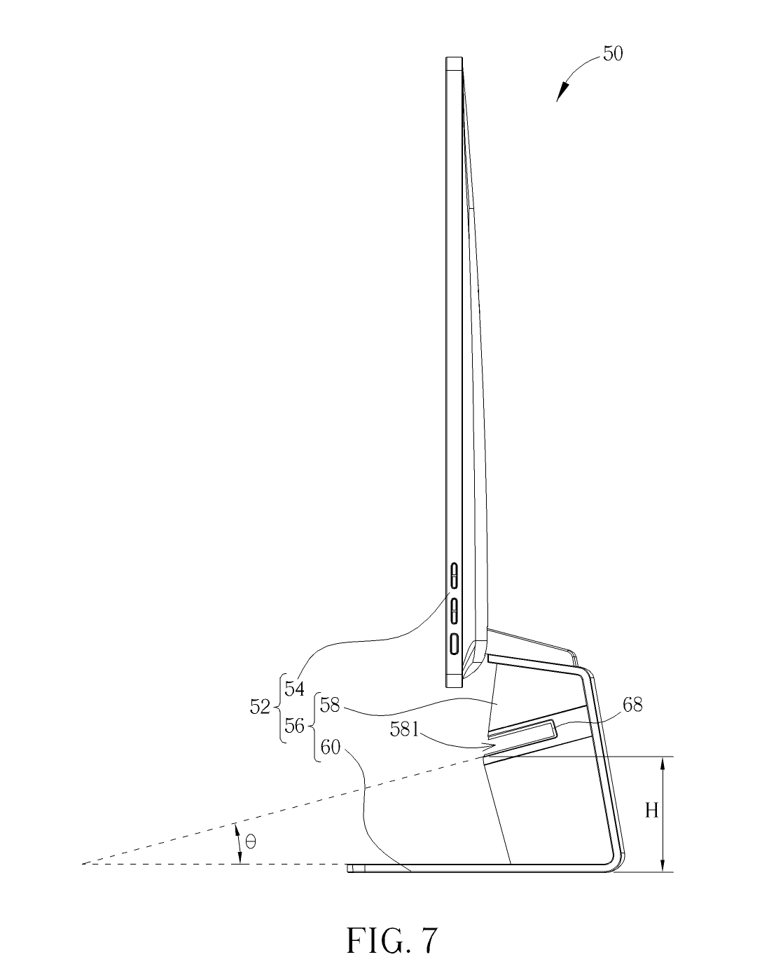

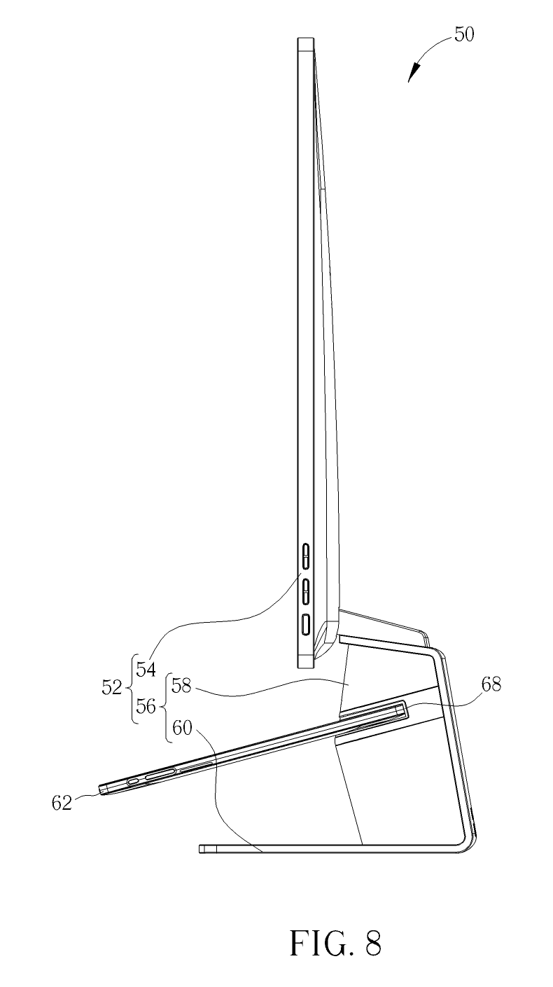

Moreover, the present invention is also to provide a mechanical design of the display device 52 combining with the touch device 62 of different sizes. Please refer FIG. 7 and FIG. 8. FIG. 7 and FIG. 8 are respectively diagrams of the computer system 50 in different states according to another embodiment of the present invention. The computer system 50 can selectively include an adjustment module 68 detachably installed inside the slot 581 of the stand body 58 for adjusting a size of an opening of the slot 581. That is, it can apply the corresponding adjustment module 68 according to different thicknesses of the touch device 62, so as to adjust the size of the opening of the slot 581 to fit the corresponding thickness of the corresponding touch device 62. For example, as the thick touch device 62 is adopted, it is not needed to install the adjustment module 68 inside the slot 581. That is, as shown in FIG. 2 and FIG. 4, the touch device 62 can be directly inserted into the slot 581 without the adjustment module 68. However, as the thin touch device 62 is adopted, as shown in FIG. 7, the adjustment module 68 corresponding to the thin touch device 62 can be installed inside the slot 581 for preventing the touch device 62 from shaking inside the slot 581. After that, as shown in FIG. 8, the touch device 62 is inserted into the slot 581 with the adjustment module 68, so as to fix the touch device 62 inside the slot 581.

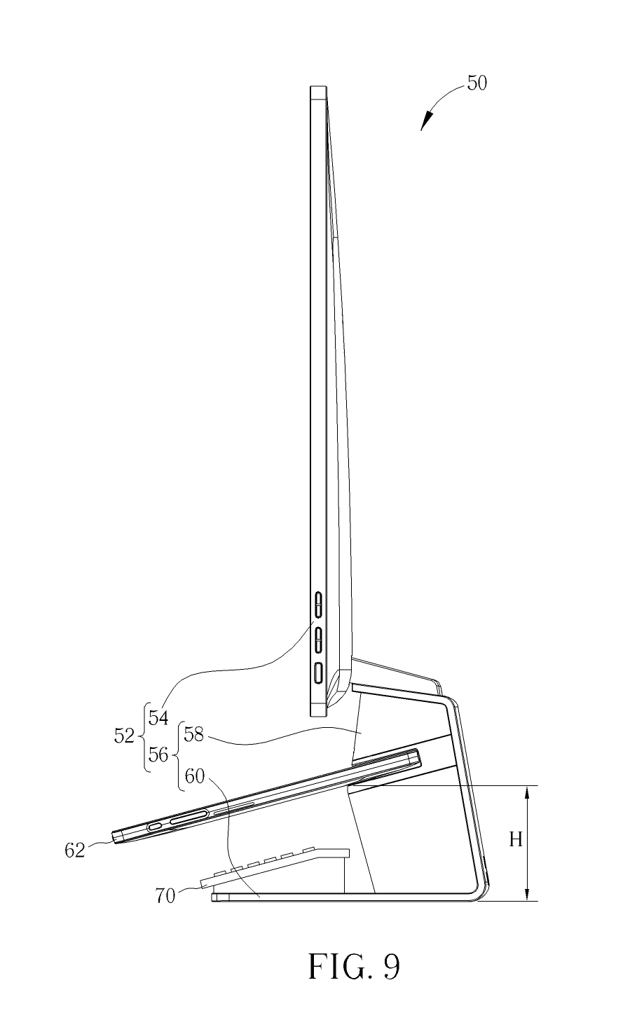

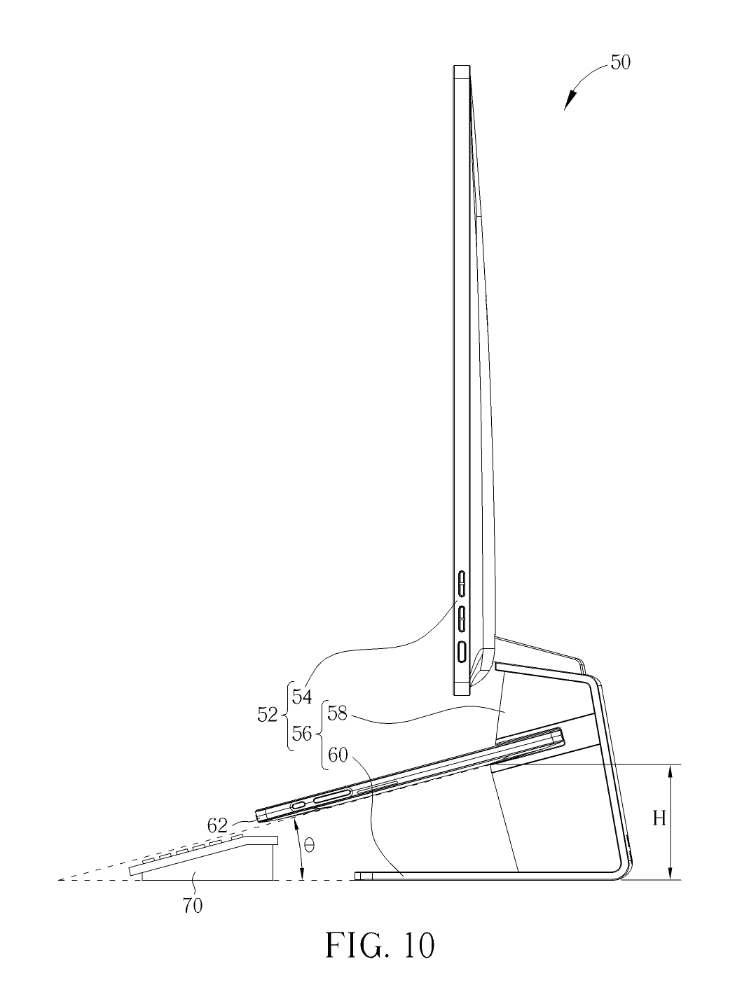

Furthermore, the predetermined height H is set between the slot 581 and the plate 60, so that the containing space is formed between the touch device 62 and the plate 60 as the touch device 62 is inserted into the slot 581. That is, the touch device 62 is suspended from the stand body 58, so as to provide the moving space for the touch device 62 to insert into the slot 581 or unplug from the slot 581. The containing space also facilitates the other peripheral input devices to be contained in the containing space under the touch device 62. Please refer to FIG. 9 and FIG. 10. FIG. 9 and FIG. 10 are respectively diagrams of the touch device 62 and a keyboard 70 in different relative positions according to another embodiment of the present invention. For example, as users only desire to use the touch interface of the touch device 62, as shown in FIG. 9, the keyboard 70 can be contained inside the containing space formed between the touch device 62 and the plate 60, so that the keyboard 60 does not occupy an operation space for users. However, as users desire to use the keyboard 70 to type and the touch interface of the touch device 62, as shown in FIG. 10, the keyboard 70 can be pulled out from the containing space between the touch device 62 and the plate 60. At this time, because the touch device 62, the keyboard 70 and the supporting surface for supporting the plate 60 cooperatively form the tilt angle θ, the tilt angle θ can facilitate users to browse the display screen 54 and the screen of the touch device 62, and it is also suitable for users to perform the touch operation on the touch device 62 and to use the keyboard 70 to type, so as to provide the ergonomic mechanical design.

In contrast to the prior art, the present invention utilizes a structural design of inserting the touch device into the slot of the display device to achieve a purpose of operating the computer system with the dual-screen function. As the touch device is inserted into the slot, the predetermined height is set under the touch device, so as to provide the moving space for the touch device to insert into the slot and unplug from the slot. The containing space also facilitates other peripheral input devices to be contained in the containing space underneath the touch device. In addition, because the slot is designed with the tilt angle, the touch device and the supporting surface for supporting the computer system also form the tilt angle as the touch device is inserted into the slot. The tilt angle can facilitate users to browse the display screen and the screen of the touch device, and it is also suitable for users to perform the touch operation on the touch device, so as to provide the ergonomic mechanical design.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device for connecting a touch device, comprising:
a display screen;
a screen stand connected to the display screen for supporting the display screen, and a slot being formed on a side of the screen stand for accommodating the touch device; and
a signal transmission port installed on an end of the slot for connecting with a connection port of the touch device as the touch device is inserted into the slot, to transmit signals to the connection port, so that the display screen displays images corresponding to the signals transmitted from the touch device.

2. The display device of claim 1, wherein the screen stand comprises:
a stand body, the slot being disposed at a side of the stand body; and
a plate connected to the stand body, a tilt angle being formed between the slot and the plate.

3. The display device of claim 2, wherein a predetermined height is set between the slot and the plate, so that a containing space is formed between the touch device and the plate as the touch device is inserted into the slot.

4. The display device of claim 2, further comprising an adjustment module detachably installed inside the slot for adjusting a size of an opening of the slot.

5. The display device of claim 2, wherein at least one hook is disposed at the end of the slot for engaging with at least one engaging portion of the touch device, so as to fix the touch device inside the slot.

6. The display device of claim 2, wherein at least one positioning column is disposed at the end of the slot for positioning at least one positioning portion of the touch device as the touch device is inserted into the slot.

7. The display device of claim 1, further comprising an adjustment module detachably installed inside the slot for adjusting a size of an opening of the slot.

8. The display device of claim 1, wherein at least one hook is disposed at the end of the slot for engaging with at least one engaging portion of the touch device, so as to fix the touch device inside the slot.

9. The display device of claim 1, wherein at least one positioning column is disposed at the end of the slot for positioning the at least one positioning portion of the touch device as the touch device is plugged into the slot.

10. The display device of claim 1, wherein the signal transmission port is a HDMI (High Definition Multimedia Interface) port.

11. A computer system, comprising:
a touch device comprising a connection port; and
a display device for connecting the touch device and displaying images of signals transmitted from the touch device, the display device comprising:
a display screen;
a screen stand connected to the display screen for supporting the display screen, and a slot being formed on a side of the screen stand for accommodating the touch device; and
a signal transmission port installed on an end of the slot for connecting with the connection port of the touch device as the touch device is inserted into the slot, to transmit the signals to the connection port, so that the display screen displays the images corresponding to the signals transmitted from the touch device.

12. The computer system of claim 11, wherein the screen stand comprises:
a stand body, the slot being disposed at a side of the stand body; and
a plate connected to the stand body, a tilt angle being formed between the slot and the plate.

13. The computer system of claim 12, wherein a predetermined height is set between the slot and the plate, so that a containing space is formed between the touch device and the plate as the touch device is inserted into the slot.

14. The computer system of claim 12, further comprising an adjustment module detachably installed inside the slot for adjusting a size of an opening of the slot.

15. The computer system of claim 12, wherein the touch device comprises at least one engaging portion, and at least one hook is disposed at the end of the slot for engaging with the at least one engaging portion of the touch device, so as to fix the touch device inside the slot.

16. The computer system of claim 12, wherein the touch device comprises at least one positioning portion, and at least one positioning column is disposed at the end of the slot for positioning the at least one positioning portion of the touch device as the touch device is inserted into the slot.

17. The computer system of claim 11, further comprising an adjustment module detachably installed inside the slot for adjusting a size of an opening of the slot.

18. The computer system of claim 11, wherein the touch device comprises at least one engaging portion, and at least one hook is disposed at the end of the slot for engaging with the at least one engaging portion of the touch device, so as to fix the touch device inside the slot.

19. The computer system of claim 11, wherein the touch device comprises at least one positioning portion, and at least one positioning column is disposed at the end of the slot for positioning the at least one positioning portion of the touch device as the touch device is inserted into the slot.

20. The computer system of claim 11, wherein the connection port of the touch device and the signal transmission port of the display device are respectively HDMI (High Definition Multimedia Interface) ports.
